(19) United States
(12) Patent Application Publication
(10) Pub. No.: US 2025/0370649 A1
(43) Pub. Date: Dec. 4, 2025

(54) STORAGE SYSTEM, ASYNCHRONOUS COPY METHOD, AND ASYNCHRONOUS COPY PROGRAM

(71) Applicant: Hitachi Vantara, Ltd., Kanagawa-ken (JP)

(72) Inventors: Ryo UENISHI, Tokyo (JP); Akihiro URANO, Tokyo (JP)

(21) Appl. No.: 19/064,288

(22) Filed: Feb. 26, 2025

(30) Foreign Application Priority Data
May 28, 2024 (JP) 2024-086590

(51) Int. Cl. G06F 3/06

(52) U.S. Cl. CPC G06F 3/0647; G06F 3/0604; G06F 3/0673

(57) ABSTRACT

In a storage system including another storage device, in which processing performance of a virtual computer that executes asynchronous copy processing of asynchronously copying data with one storage device that executes input and output processing of data in response to a request from a host device may be changed, a processing performance adjustment unit changes in advance processing performance required at a second time point temporally later than a first time point by the virtual computer of the other storage device before the second time point when the asynchronous copy processing is executed at the second time point according to a state of the input and output processing at the first time point in the one storage device.

### CROSS-REFERENCE TO PRIOR APPLICATION

This application relates to and claims the benefit of priority from Japanese Patent Application number 2024-086590, filed on May 28, 2024 the entire disclosure of which is incorporated herein by reference.

### BACKGROUND OF THE INVENTION

### 1. Field of the Invention

The present invention relates to a storage system, an asynchronous copy method, and an asynchronous copy program, and is preferably applied to, for example, a storage system related to a technique of executing asynchronous copy between a plurality of sites.

### 2. Description of the Related Art

For example, as a method of adjusting performance of an instance in a node using an instance that is a virtual computer, there is a technique disclosed in JP 2023-100222 A. In the technique disclosed in JP 2023-100222 A, in a case where processing performance such as a utilization rate of a central processing unit (CPU) and a memory usage amount at a current time point of an instance is a predetermined threshold, an instance type (for example, a CPU frequency, the number of cores, or the memory capacity) indicating a type of processing performance of the instance is changed.
Patent Literature: JP 2023-100222 A

### SUMMARY OF THE INVENTION

However, in the technique disclosed in JP 2023-100222 A, the processing performance required at a current time point is considered, processing performance required in the future is not considered, and processing performance required in the future in an instance cannot be prepared in advance.

The present invention has been made in view of the above point, and is to propose a storage system, an asynchronous copy method, and an asynchronous copy program capable of continuously maintaining performance higher than a certain level regarding asynchronous copy between a plurality of sites by preparing processing performance required in the future in advance.

In order to solve such a problem, the present invention includes one storage device that executes input and output processing of data in response to a request from a host device, another storage device that includes a virtual computer that executes asynchronous copy processing of asynchronously copying the data with the one storage device, processing performance of the virtual computer being able to be changed, and a processing performance adjustment unit that changes in advance processing performance required at a second time point temporally later than a first time point by the virtual computer of the other storage device before the second time point when the asynchronous copy processing is executed at the second time point according to a state of the input and output processing at the first time point in the one storage device.

In the present application, there is provided an asynchronous copy method of a storage system including another storage device in which processing performance of a virtual computer that executes asynchronous copy processing of asynchronously copying data with one storage device that executes input and output processing of the data in response to a request from a host device can be changed, and a processing performance adjustment unit executes a processing performance adjustment step for changing in advance processing performance required at a second time point temporally later than a first time point by the virtual computer of the other storage device before the second time point when the asynchronous copy processing is executed at the second time point according to a state of the input and output processing at the first time point in the one storage device.

The present application is implemented by an asynchronous copy program of a storage system including another storage device in which processing performance of a virtual computer that executes asynchronous copy processing of asynchronously copying data with one storage device that executes input and output processing of the data in response to a request from a host device can be changed, the asynchronous copy program causing a processing performance adjustment unit to execute, on a computer, a processing performance adjustment step of changing in advance processing performance required at a second time point temporally later than a first time point by the virtual computer of the other storage device before the second time point when asynchronous copy processing is executed at the second time point according to a state of the input and output processing at the first time point in the one storage device, and a processing performance adjustment unit to execute, on a computer, a display step of displaying a predetermined screen for changing the processing performance in advance.

According to the present invention, it is possible to implement a storage system, an asynchronous copy method, and an asynchronous copy program capable of continuously maintaining performance higher than a certain level regarding asynchronous copy between a plurality of sites by preparing processing performance required in the future in advance.

### BRIEF DESCRIPTION OF THE DRAWINGS

FIG. 1 is a system configuration diagram illustrating a hardware configuration example of an information system including a storage system according to the present embodiment;

FIG. 2 is a system configuration diagram illustrating a software configuration example of a management server in the information system including the storage system illustrated in FIG. 1;

FIG. 3 is a diagram illustrating an example of asynchronous copy processing of data using a journal between a plurality of storage devices;

FIG. 4 is a diagram illustrating an example of verification of processing performance between a storage device in an on-premises environment and a storage device in a cloud environment at the time of data writing;

FIG. 5 is a flowchart illustrating an example of processing performance change processing;

FIG. 6 is a flowchart illustrating an example of a procedure of on-premises environment performance information acquisition processing illustrated in FIG. 5;

FIG. 7 is a flowchart illustrating an example of a procedure of on-premises environment performance information determination processing illustrated in FIG. 5;

FIG. 8A is a flowchart illustrating an example of a procedure of determination processing in a case where a value exceeds an upper limit threshold illustrated in FIG. 7;

FIG. 8B is a flowchart illustrating an example of a procedure of determination processing in a case where a value falls below a lower limit threshold illustrated in FIG. 7;

FIG. 9 is a flowchart illustrating an example of a procedure of cloud environment performance information change processing illustrated in FIG. 5;

FIG. 10 is a flowchart illustrating an example of a procedure of cloud environment memory change processing illustrated in FIG. 9;

FIG. 11 is a flowchart illustrating an example of a procedure of cloud environment CPU change processing illustrated in FIG. 9;

FIG. 12 is a diagram illustrating an example of a method of calculating an enhancement value or the like of a memory and a CPU when each condition is satisfied;

FIG. 13 is a diagram illustrating an example of the method of calculating an enhancement value or the like of a memory and a CPU when each condition is satisfied;

FIG. 14 is a diagram illustrating an example of the method of calculating an enhancement value or the like of a memory and a CPU when each condition is satisfied;

FIG. 15 is a diagram illustrating an example of the method of calculating an enhancement value or the like of a memory and a CPU when each condition is satisfied;

FIG. 16 is a diagram illustrating an example of the method of calculating an enhancement value or the like of a memory and a CPU when each condition is satisfied;

FIG. 17 is a diagram illustrating an example of the method of calculating an enhancement value or the like of a memory and a CPU when each condition is satisfied; and

FIG. 18 is a diagram illustrating an example of a monitoring screen.

### DESCRIPTION OF THE PREFERRED EMBODIMENTS

Hereinafter, an embodiment of the present invention will be described in detail with reference to the drawings.

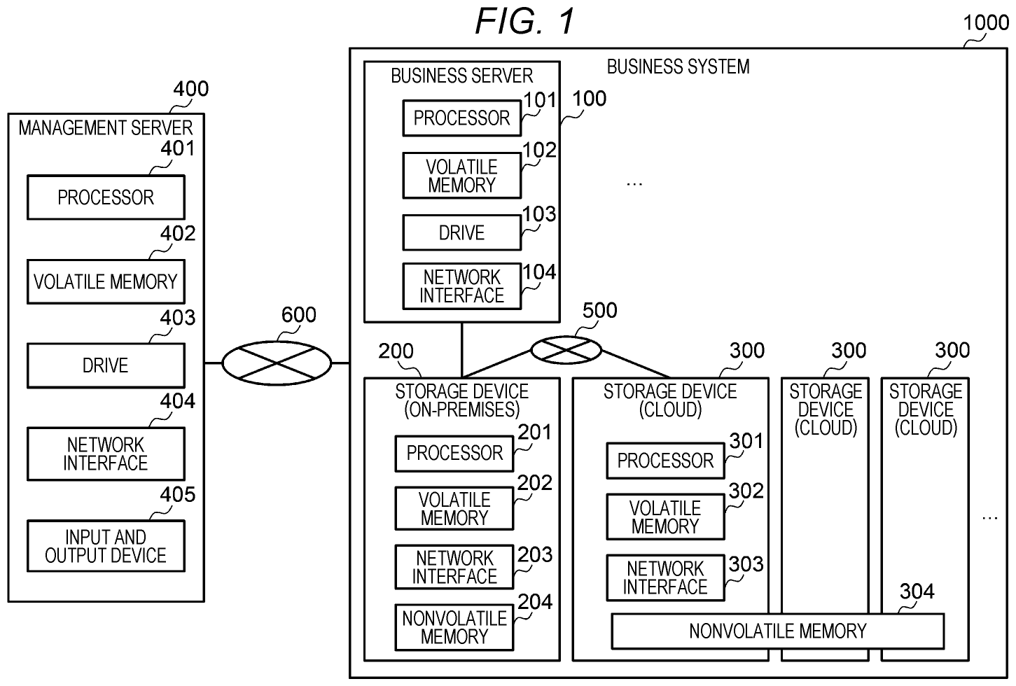

FIG. 1 is a system configuration diagram illustrating a hardware configuration example of an information system including a storage system according to the present embodiment. A business system 1000 as an example of the storage system according to the present embodiment is connected to, for example, a management server 400, which is a computer on which a storage control program to be described later operates, via a network 600.

The business system 1000 includes a business server 100, a storage device 200 in what is called an on-premises environment, at least one storage device 300 in what is called a cloud environment, and a network 500. In the storage device 200 and the storage device 300, an operating system (hereinafter also referred to as “OS”) operates. As a command (for example, iostat) or the like provided by the OS is executed, the OS can acquire processing performance of any or a combination of any of a data write amount, a data write count, a usage rate of a CPU as an example of a processor 201, a network bandwidth usage rate, and the like.

The business server 100 is connected to the storage device 200 in an on-premises environment and can exchange data with each other. The storage device 200 in an on-premises environment and at least one of the storage devices 300 in a cloud environment are connected via the network 500 and can exchange data with each other. In the cloud environment, a plurality of the storage devices 300 are provided. Note that, hereinafter, for simplification of description, it is assumed that the number of the storage devices 300 in a cloud environment is one.

The storage device 200 in an on-premises environment and the storage device 300 in a cloud environment are examples of a plurality of storage devices that execute asynchronous copy processing in order to share data to be read and written in response to an IO request of the business server 100 between the storage devices, and do not need to be in an on-premises environment and a cloud environment, respectively.

The business server 100 includes a processor 101, a volatile memory 102, a drive 103, and a network interface 104.

The processor 101 is a central processing unit that controls the business server 100. The volatile memory 102 is a volatile storage device capable of temporarily storing data. The drive 103 is a drive device such as a hard disk drive or a solid state drive (SSD). The network interface 104 is a network interface for connecting to at least the storage device 200 in an on-premises environment.

The storage device 200 in an on-premises environment includes a processor 201, a volatile memory 202, a network interface 203, and a nonvolatile memory 204. The storage device 200 in an on-premises environment operates as what is called a virtual computer, and performance of the processor 201, the volatile memory 202, the network interface 203, and the nonvolatile memory 204 can be changed according to settings.

The processor 201 is a central processing unit that controls the storage device 200. The volatile memory 202 is a volatile storage device capable of temporarily storing data. The network interface 203 is a network interface for connecting to the storage device 300 in a cloud environment via the network 500 or connecting to the business server 100. The nonvolatile memory 204 is a nonvolatile storage device capable of storing data, and has, for example, a primary volume from and to which data can be read and written.

In the present embodiment, a situation where it is necessary to change performance of the processor 201, the volatile memory 202, the network interface 203, and the nonvolatile memory 204 as described above is, for example, a situation where it is necessary to adjust processing performance required for the side of the storage device 300 in a cloud environment when the storage device 300 in a cloud environment executes asynchronous copy processing of data between the storage device 200 in an on-premises environment and the storage device 300 in a cloud environment.

The storage device 300 in a cloud environment includes a processor 301, a volatile memory 302, a network interface 303, and a nonvolatile memory 304. Note that the nonvolatile memory 304 may be shared between a plurality of the storage devices 300 in a cloud environment. Hereinafter, the present embodiment will be described assuming that one of the storage device 300 in a cloud environment is provided.

The processor 301 is a central processing unit that controls the storage device 300. The volatile memory 302 is a volatile storage device capable of temporarily storing data. The network interface 303 is a network interface for connecting to the storage device 200 in an on-premises environment via the network 500. The nonvolatile memory 304 is a nonvolatile storage device capable of storing data, and includes, for example, a secondary volume to be described later from and to which data can be read and written. The nonvolatile memory 304 may be configured across a plurality of the storage devices 300, for example.

The management server 400 includes a processor 401, a volatile memory 402, a drive 403, a network interface 404, and an input and output device 405 as hardware.

The processor 401 is a central processing unit that controls the management server 400. The volatile memory 402 is a volatile storage device capable of temporarily storing data. The drive 403 is a drive device such as a hard disk drive or an SSD. The network interface 404 is a network interface for connecting to the business system 1000 via the network 600. The nonvolatile memory 304 is a nonvolatile storage device capable of storing data. The input and output device 405 is a device for the user operating the management server 400 to input or output information for operating the management server 400.

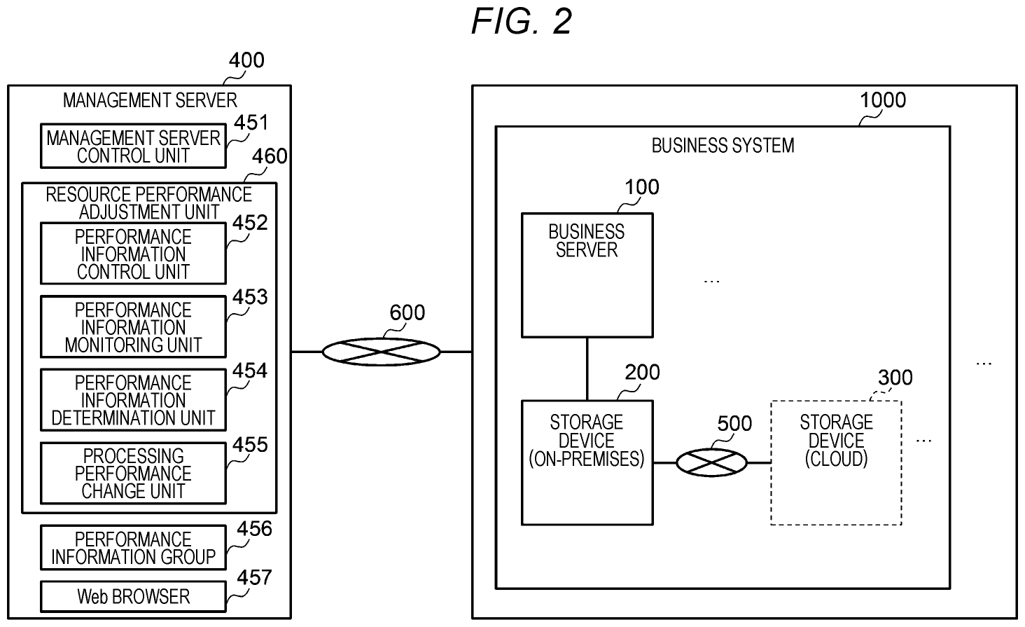

FIG. 2 is a system configuration diagram illustrating a software configuration example (corresponding to a configuration example of a storage control program to be described later) mainly of the management server 400 in an information system including the storage system illustrated in FIG. 1. As described above, the business system 1000 as an example of the storage system according to the present embodiment is connected to the management server 400 via the network 600.

The storage system according to the present embodiment includes the storage device 200 in an on-premises environment as an example of one storage device that executes data input and output processing in response to a request from the business server 100 as an example of a host device, and the storage device 300 in a cloud environment including a virtual computer that executes processing of copying data asynchronously (hereinafter referred to as “asynchronous copy processing”) with the storage device 200 in an on-premises environment, in which processing performance of the virtual computer may be changed. The virtual computer is created according to necessary processing performance, and for example, processing performance (performance value) of a central processing unit (CPU), a memory, and the like can be changed according to settings.

The management server 400 controls the storage device 200 in an on-premises environment and the storage device 300 in a cloud environment. The management server 400 includes, as software, a management server control unit 451, a processing performance adjustment unit 460, a performance information group 456, and a World Wide Web (Web) browser 457. The performance information group 456 is, for example, performance information regarding various resources (for example, at least any or a combination of any of the processor 301, the volatile memory 302, the network interface 303, and the nonvolatile memory 304) acquired from the storage device 300 in a cloud environment, and includes various types of performance information regarding processing performance of the storage device 300 in a cloud environment.

Note that the performance information group 456 may be performance information regarding various resources (for example, the processor 201, the volatile memory 202, the network interface 203, and the nonvolatile memory 204) acquired from the storage device 200 in an on-premises environment, and may include various types of performance information regarding processing performance of the storage device 200 in an on-premises environment.

The management server 400 is, for example, a computer, and a storage control program operating on an OS of the computer is operated. The storage control program is a program for controlling the storage device 200 in an on-premises environment and the storage device 300 in a cloud environment in response to investigation by a management user via the management server 400.

When, according to a state of input and output processing at a certain time point (hereinafter referred to as a “first time point”) in the storage device 200 in an on-premises environment as a copy source, asynchronous copy processing is executed at a time point (hereinafter referred to as a “second time point”) that is temporally later than the first time point, the processing performance adjustment unit 460 has a function of changing, in advance, processing performance required at the second time point by the virtual computer of the storage device 300 in a cloud environment as a copy destination before the second time point.

The processing performance adjustment unit 460 includes a performance information control unit 452, a performance information monitoring unit 453, a performance information determination unit 454, and a processing performance change unit 455. Hereinafter, the processing performance adjustment unit 460 will be described in detail.

The performance information control unit 452 controls the performance information monitoring unit 453, the performance information determination unit 454, and the processing performance change unit 455 included in the processing performance adjustment unit 460. The performance information monitoring unit 453 has a function of monitoring processing performance of the storage device 300 in a cloud environment. The performance information determination unit 454 has a function of determining whether or not it is necessary to increase or decrease processing performance of the storage device 300 in a cloud environment. A specific determination method will be described later. The processing performance change unit 455 changes processing performance of the storage device 300 in a cloud environment. A specific changing method will be described later.

For example, in a case where a processing load is a threshold or more as a state of input and output processing at the first time point in the storage device 200 in an on-premises environment, the processing performance change unit 455 changes processing performance required at the second time point by the virtual computer of the storage device 300 in a cloud environment to be high.

Further, for example, in a case where a processing load is equal to or less than a threshold as a state of input and output processing at the first time point in the storage device 200 in an on-premises environment, the processing performance change unit 455 may change processing performance required at the second time point by the virtual computer of the storage device 300 in a cloud environment to be low.

The processing performance adjustment unit 460 changes processing performance of at least one of a memory and a processor included in the storage device 300 in a cloud environment as processing performance of the storage device 300 in a cloud environment.

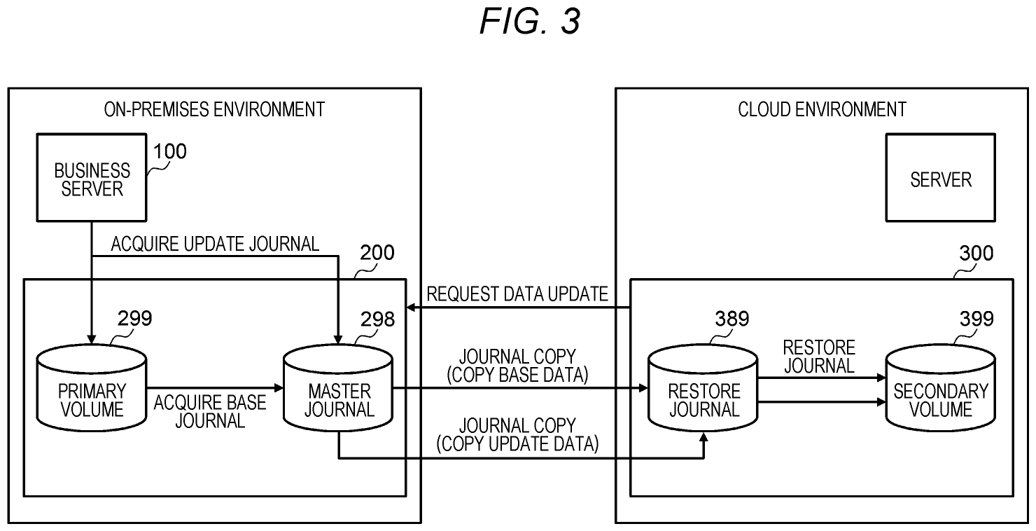

FIG. 3 is a diagram illustrating an example of asynchronous copy processing of data using a journal between a plurality of storage devices. In the present embodiment, the storage device 200 in an on-premises environment and the storage device 300 in a cloud environment are exemplified as an example of a plurality of storage devices.

The storage device 200 in an on-premises environment includes a primary volume 299 as an example of one volume to which data is written, and a master journal 298 that stores a base journal corresponding to data written to the primary volume 299 and an update journal corresponding to a difference between data written after that and data already written to the primary volume 299.

The storage device 300 in a cloud environment includes a restore journal 398 to which a base journal and an update journal stored in the master journal 298 are copied, and a secondary volume 399 as an example of another volume on which data is restored based on the restore journal 398.

In the storage device 200 in an on-premises environment, when data from the business server 100 is written to the primary volume 299, a base journal corresponding to the written data is acquired and written to the master journal 298.

After the above, when there is another data write request, in the storage device 200 in an on-premises environment, an update journal corresponding to a difference between data written to the primary volume 299 and data already written to the primary volume 299 is acquired and written to the master journal 298. More specifically, the storage device 200 in an on-premises environment writes update data (actual data) from the business server 100 and control information (metadata) added to the update data to the master journal 298.

On the other hand, in the storage device 300 in a cloud environment, when a data update request is issued to the storage device 200 in an on-premises environment, the storage device 200 in an on-premises environment copies a base journal of the master journal 298 to the restore journal 398 and copies an update journal of the master journal 298 to the restore journal 398.

The storage device 300 in a cloud environment restores the above data in the secondary volume 399 based on the restore journal 398, so as to duplicate the data between the storage device 200 in an on-premises environment and the storage device 300 in a cloud environment.

At this time, between the storage device 300 in a cloud environment and the storage device 200 in an on-premises environment, performance can be analyzed using not only a write amount of data with respect to a journal but also, for example, network bandwidth between a plurality of journals.

In the present embodiment, based on an amount of data written in the restore journal 398, for example, determination of increase or decrease in processing performance (performance value) of a virtual computer on the side of the storage device 300 in a cloud environment and adjustment of a copy amount of data by asynchronous copy processing are performed.

On the other hand, in the storage device 200 in an on-premises environment, by control of a storage control program, journal restoration is performed using a base journal and an update journal of the restore journal 398 as described above, and data is restored in the secondary volume 399.

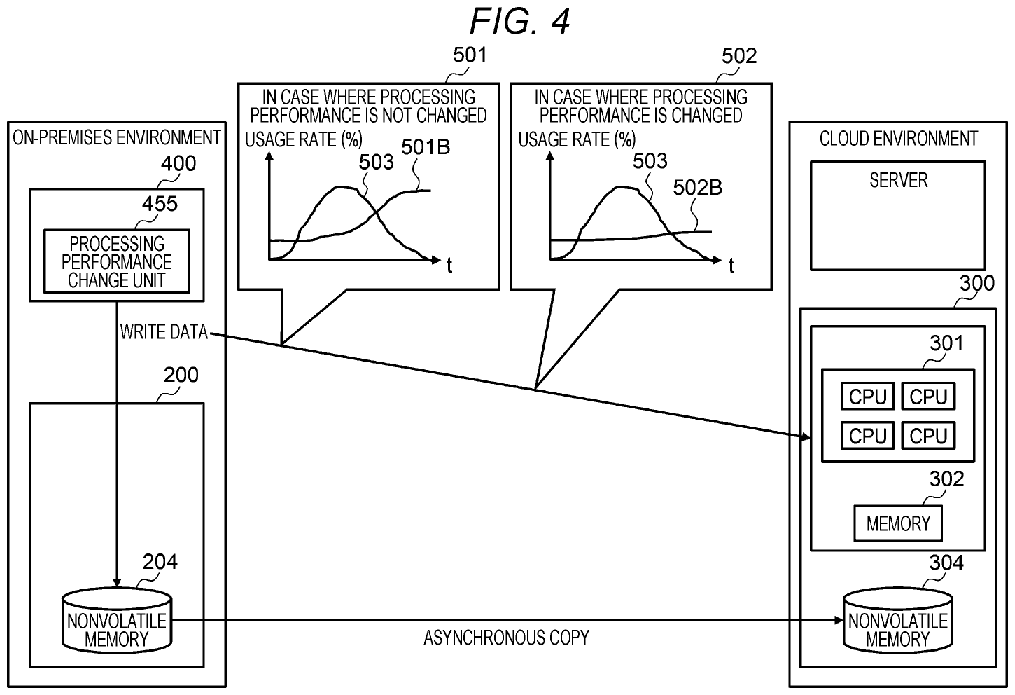

FIG. 4 is a diagram illustrating an example of verification of processing performance between the storage device 200 in an on-premises environment and the storage device 300 in a cloud environment at the time of data writing.

In the present embodiment, the performance information determination unit 454 predicts a load on the storage device 300 in a cloud environment at the second time point described above from a performance value (data write amount described later, and the like) of the storage device 200 in an on-premises environment at the first time point described above, and the processing performance change unit 455 increases or decreases processing performance of the storage device 300 in a cloud environment in advance if necessary based on the prediction.

The performance information determination unit 454 can employ a method as described below as determination as to whether or not it is necessary to increase or decrease processing performance of the storage device 300 in a cloud environment. That is, the performance information determination unit 454 can employ, for example, a method of determining whether to increase or decrease processing performance according to a difference between a performance value of the storage device 300 in a cloud environment and a threshold (an upper limit threshold and a lower limit threshold to be described later), a method of determining according to a ratio between a performance value of the storage device 300 in a cloud environment and a threshold, or a method of determining according to the number of times a performance value of the storage device 300 in a cloud environment exceeds a threshold (the number of times of exceeding).

For example, in a processing performance characteristic 501 in a case where the processing performance change unit 455 does not change processing performance, in the storage device 200 in an on-premises environment, for example, a characteristic 503 of an on-premises environment regarding processing performance of a usage rate of a CPU of the storage device 300 in a cloud environment as a vertical axis decreases after reaching a peak at a predetermined time, whereas a data communication amount between the storage device 200 in an on-premises environment and the storage device 300 in a cloud environment tends to increase with lapse of time t. With such a tendency, in the storage device 300 in a cloud environment, a load is expected to increase with lapse of the time t until the predetermined time. Therefore, the processing performance change unit 455 needs to change to improve processing performance on the side of the storage device 300 in a cloud environment. Note that the processing performance characteristic 501 described above may be, for example, a characteristic in which any of a data write amount, the number of times of data writing, and a network bandwidth usage rate is set as a vertical axis, instead of the CPU usage rate described above.

On the other hand, for example, in a processing performance characteristic 502 in a case where the processing performance change unit 455 changes processing performance, in the storage device 200 in an on-premises environment, for example, a characteristic 503 in an on-premises environment regarding processing performance of a usage rate of a CPU of the storage device 300 in a cloud environment as a vertical axis decreases after reaching a peak in predetermined time, whereas a usage rate of a CPU between the storage device 200 in an on-premises environment and the storage device 300 in a cloud environment tends to be substantially flat until the predetermined time without increasing even after lapse of the time t. With such a tendency, in the storage device 300 in a cloud environment, it is expected that a load does not increase even after lapse of the time t. Therefore, the processing performance change unit 455 can maintain processing performance on the side of the storage device 300 in a cloud environment without any change. Note that the processing performance characteristic 502 described above may be, for example, a characteristic in which any of a data write amount, the number of times of data writing, and a network bandwidth usage rate is set as a vertical axis, instead of the CPU usage rate described above.

The business system 1000 including the storage system according to the present embodiment has the above configuration, and next, an outline of an asynchronous copy method as an operation example of the storage system according to the present embodiment will be described. The asynchronous copy method is an asynchronous copy method of a storage system including the storage device 300 in a cloud environment, in which processing performance of a virtual computer may be changed, the virtual computer executing asynchronous copy processing of asynchronously copying data with the storage device 200 in an on-premises environment that executes input and output processing of data in response to a request from the business server 100, and the processing performance adjustment unit 460 executes a processing performance adjustment step of changing in advance processing performance required at the second time point temporally later than the first time point by a virtual computer of the storage device 300 in a cloud environment before the second time point when asynchronous copy processing is executed at the second time point according to a state of input and output processing at the first time point in the storage device 200 in an on-premises environment.

A storage control program causes the processing performance adjustment unit 460 to execute the processing performance adjustment step, and causes the processing performance adjustment unit 460 to execute a display step of displaying a predetermined screen for changing in advance processing performance of a virtual computer of the storage device 300 in a cloud environment on a computer. When executing the processing performance adjustment step described above, the storage control program displays a monitoring screen and a main screen to be described later as an example of the predetermined screen. Hereinafter, specific description will be given.

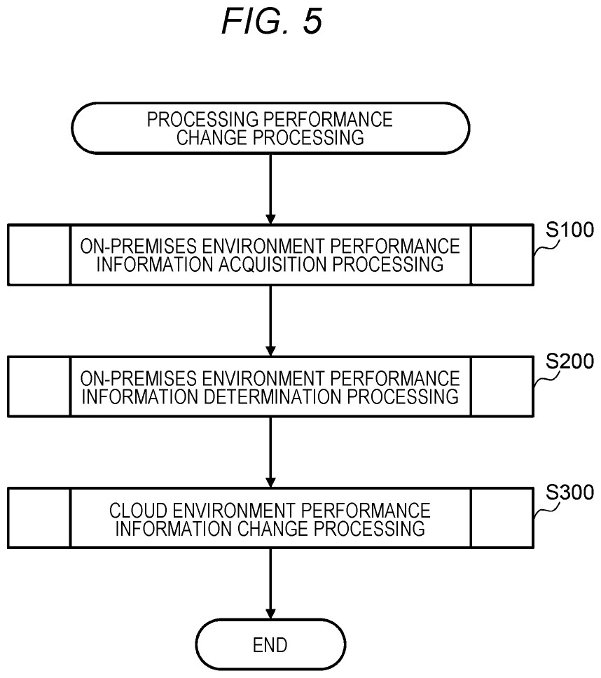

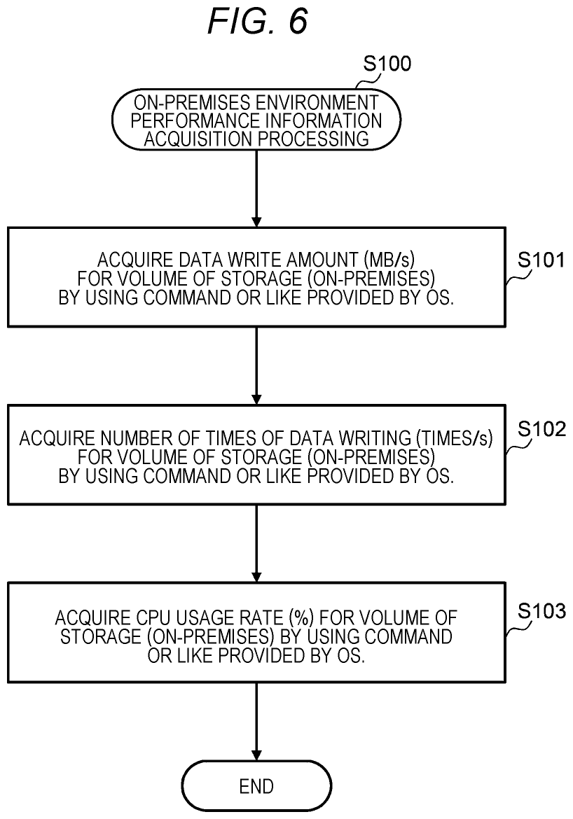

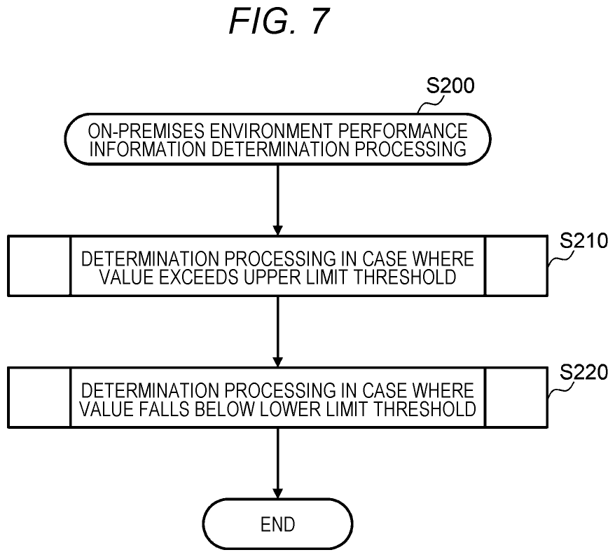

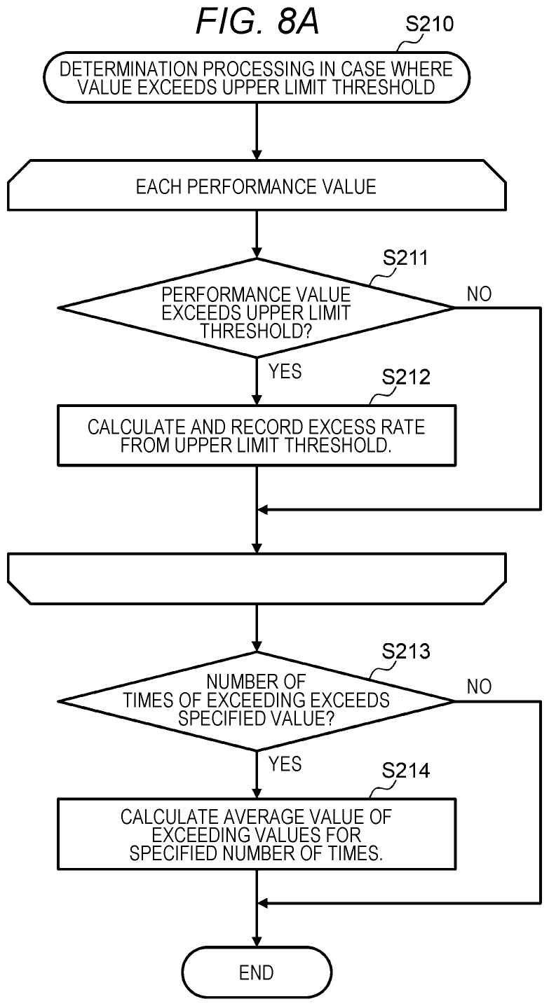

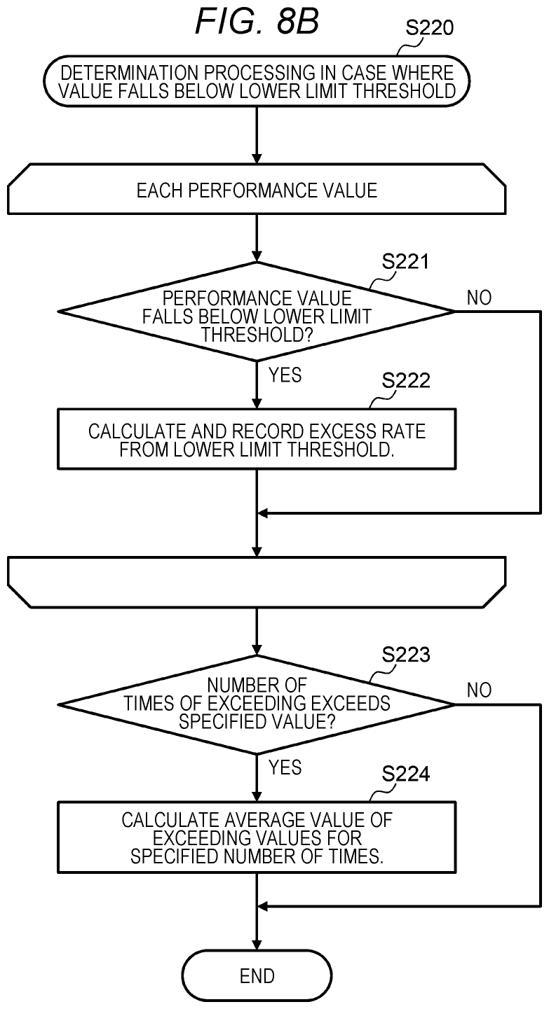

FIG. 5 is a flowchart illustrating an example of processing performance change processing, FIG. 6 is a flowchart illustrating an example of a procedure of on-premises environment performance information acquisition processing S100 illustrated in FIG. 5, and FIG. 7 is a flowchart illustrating an example of a procedure of on-premises environment performance information determination processing S200 illustrated in FIG. 5. FIG. 8A is a flowchart illustrating an example of a procedure of determination processing in a case where a value exceeds an upper limit threshold illustrated in FIG. 7 is exceeded, and FIG. 8B is a flowchart illustrating an example of a procedure of determination processing in a case where a value falls below a lower limit threshold illustrated in FIG. 7.

As illustrated in FIG. 5, the processing performance change processing includes the on-premises environment performance information acquisition processing S100, the on-premises environment performance information determination processing S200, and cloud environment performance information change processing S300.

As illustrated in FIG. 6, in the on-premises environment performance information acquisition processing S100, in Step S101, the performance information monitoring unit 453 acquires processing performance such as a data write amount (MB/s) for a volume (primary volume 299) of the storage device 200 in an on-premises environment by using a command (for example, iostat) provided by an operating system. For example, in a case where a data collection interval is set to one minute, the performance information monitoring unit 453 executes a command at one minute intervals.

In Step S102, the performance information monitoring unit 453 acquires processing performance such as the number of times of data writing (times/s) for a volume (primary volume 299) of the storage device 200 in an on-premises environment by using a command (for example, iostat) or the like provided by an OS.

In Step S103, the performance information monitoring unit 453 acquires a CPU usage rate (%) for a volume (primary volume 299) of the storage device 200 in an on-premises environment by using a command (for example, iostat) or the like provided by an OS.

The on-premises environment performance information determination processing S200 illustrated in FIG. 7 includes determination processing S210 in a case where a value exceeds an upper limit threshold and determination processing S220 in a case where a value falls below a lower limit threshold.

As illustrated in FIG. 8A, in the determination processing S210 in a case where a value exceeds an upper limit threshold, in Step S211, the performance information monitoring unit 453 executes Step S212 in a case where a target performance value exceeds an upper limit threshold for each performance value. In Step S212, the performance information monitoring unit 453 calculates and records, for example, an excess rate from an upper limit threshold.

Next, in Step S213, the performance information monitoring unit 453 executes Step S214, for example, in a case where the number of times of exceeding exceeds a specified value. In Step S214, the performance information monitoring unit 453 calculates, for example, an average value of exceeding values for a specified number of times.

On the other hand, in the determination processing S220 in a case where a value falls below a lower limit threshold illustrated in FIG. 8B, in Step S221, the performance information monitoring unit 453 executes Step S222 in a case where a target performance value falls below a lower limit threshold for each performance value. In Step S222, the performance information monitoring unit 453 calculates and records, for example, an excess rate from a lower limit threshold. Note that the processing performance change unit 455 may change a performance value in a case where each performance value exceeds a threshold, or may set a combination of specific performance values.

Next, in Step S223, the performance information monitoring unit 453 executes Step S224 in a case where the number of times of exceeding exceeds a specified value. Note that, in order to exclude a case where a spike value occurs, the performance information monitoring unit 453 checks, for example, whether a specified number of times is exceeded. For example, in a case where a default number of times of exceeding is seven out of ten, in a case where performance values are acquired at data collection intervals of one minute, the performance information monitoring unit 453 checks data of latest ten times at the stage of acquiring data of ten times (ten data points acquired every one minute), and if the number of times of exceeding a threshold exceeds seven, calculates an average value of exceeding values for seven times. Next, in Step S224, the performance information monitoring unit 453 calculates an average value of exceeding values for a specified number of times.

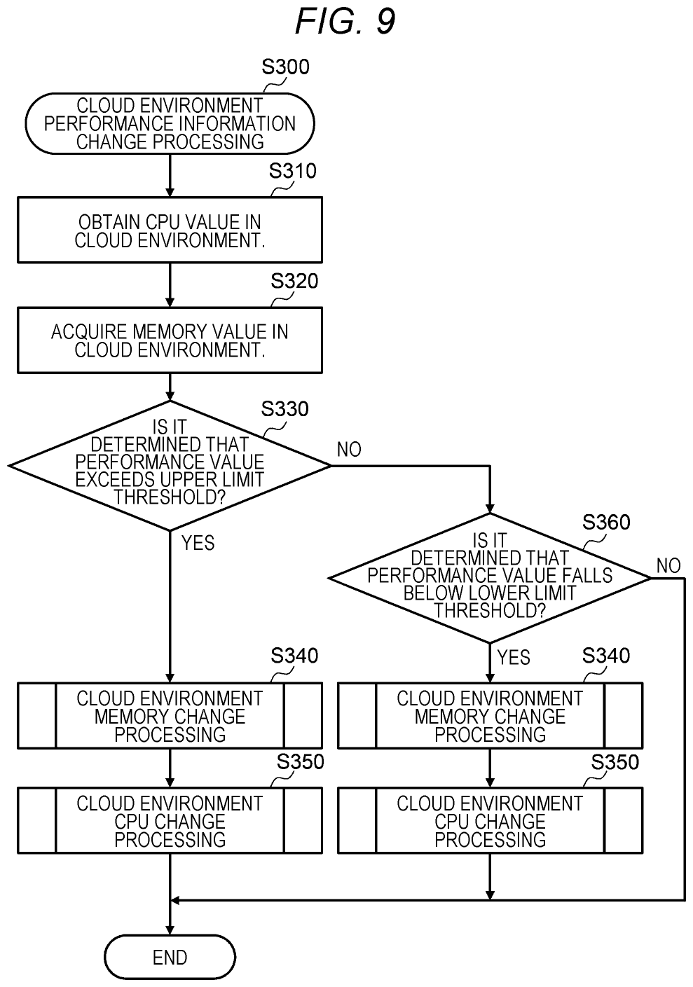

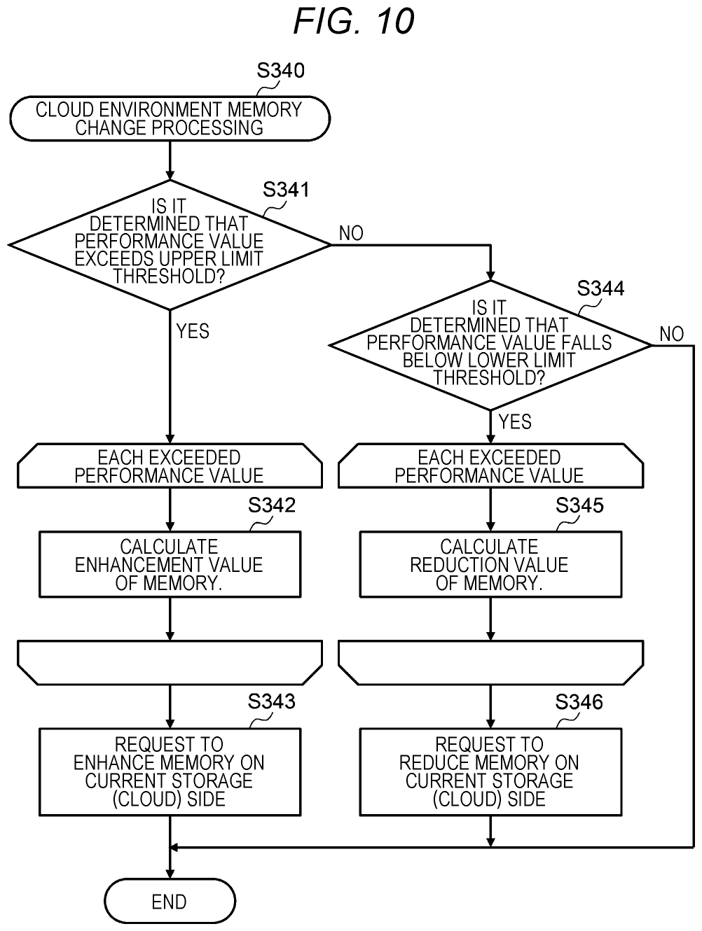

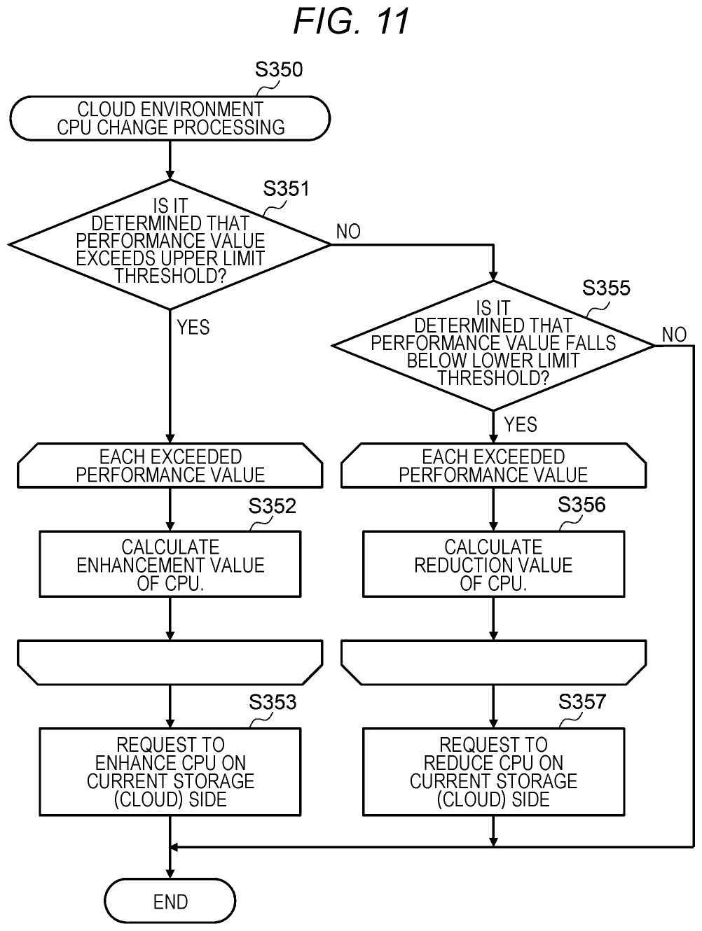

FIG. 9 is a flowchart illustrating an example of a procedure of the cloud environment performance information change processing S300 illustrated in FIG. 5, FIG. 10 is a flowchart illustrating an example of a procedure of cloud environment memory change processing (Step S340) illustrated in FIG. 9, and FIG. 11 is a flowchart illustrating an example of a procedure of cloud environment CPU change processing (Step S350) illustrated in FIG. 9.

In the cloud environment performance information change processing S300 illustrated in FIG. 9, in Step S310, the performance information monitoring unit 453 acquires a CPU value in a cloud environment by, for example, the above-described command or the like. In Step S311, the performance information monitoring unit 453 acquires a memory value in a cloud environment by, for example, the above-described command or the like.

In Step S312, in a case where the performance information determination unit 454 determines that a target performance value exceeds an upper limit threshold based on a calculation method based on mapping of a condition and a calculation method to be described later, the processing performance change unit 455 executes Steps S340 and S350, whereas in a case where the performance information determination unit 454 does not determine that a target performance value exceeds an upper limit threshold, whether or not the target performance value is determined to fall below a lower limit threshold based on a calculation method based on mapping of a condition and a calculation method to be described later.

In a case where it is determined that a target performance value falls below a lower limit threshold, the processing performance change unit 455 executes Step S340 (cloud environment memory change processing) and Step S350 (cloud environment CPU change processing), whereas in a case it is not determined as such, the processing performance change unit 455 does not execute Step S340 or Step S350.

In Step S340 (cloud environment performance information change processing) illustrated in FIG. 10, in a case where the performance information determination unit 454 determines in Step S341 that a current performance value of a virtual computer on the side of the storage device 300 in a cloud environment exceeds an upper limit threshold, the processing performance change unit 455 executes Step S342 for each exceeded performance value.

In Step S342, the processing performance change unit 455 calculates an enhancement value of a memory based on a calculation method based on mapping of a condition and a calculation method to be described later.

Next, in Step S343, the processing performance change unit 455 requests to enhance a current memory on the side of the storage device 300 in a cloud environment based on a largest value among enhancement values of a memory calculated from each performance value.

On the other hand, when it is not determined in Step S341 described above that a target performance value exceeds an upper limit threshold, the performance information determination unit 454 calculates a reduction value of a memory based on a calculation method based on mapping of a condition and a calculation method to be described later for each exceeded performance value.

Next, in Step S346, the processing performance change unit 455 requests reduction of a current memory on the side of the storage device 300 in a cloud environment based on a largest value among reduction values of a memory calculated from each performance value.

In Step S350 (cloud environment memory change processing) illustrated in FIG. 11, in a case where the performance information monitoring unit 453 determines in Step S351 that a performance value exceeds an upper limit threshold, the performance information determination unit 454 executes Step S352 for each exceeded performance value.

In Step S352, the performance information determination unit 454 calculates a reduction value of a CPU based on a calculation method based on mapping of a condition and a calculation method to be described later. Next, in Step S353, the processing performance change unit 455 requests to enhance a current CPU on the side of the storage device 300 in a cloud environment based on a largest value among enhancement values of a memory calculated from each performance value.

On the other hand, when it is not determined in Step S351 described above that a performance value exceeds an upper limit threshold, the performance information determination unit 454 calculates a reduction value of a CPU based on a calculation method based on mapping of a condition and a calculation method to be described later for each exceeded performance value.

Next, in Step S356, the processing performance change unit 455 requests reduction of a current CPU on the side of the storage device 300 in a cloud environment based on a largest value among reduction values of a CPU calculated from each performance value.

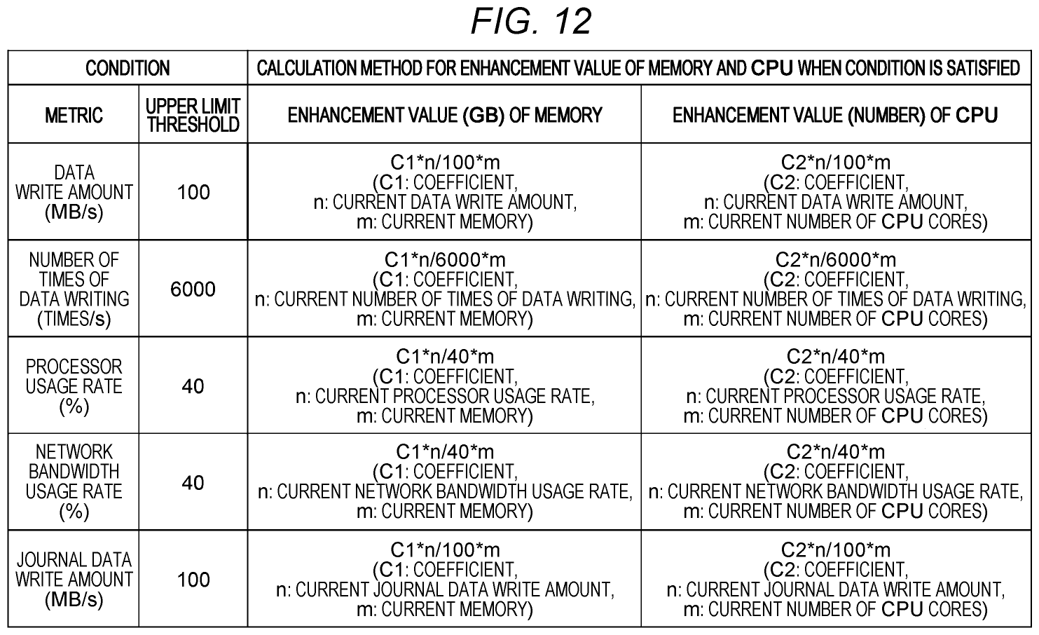

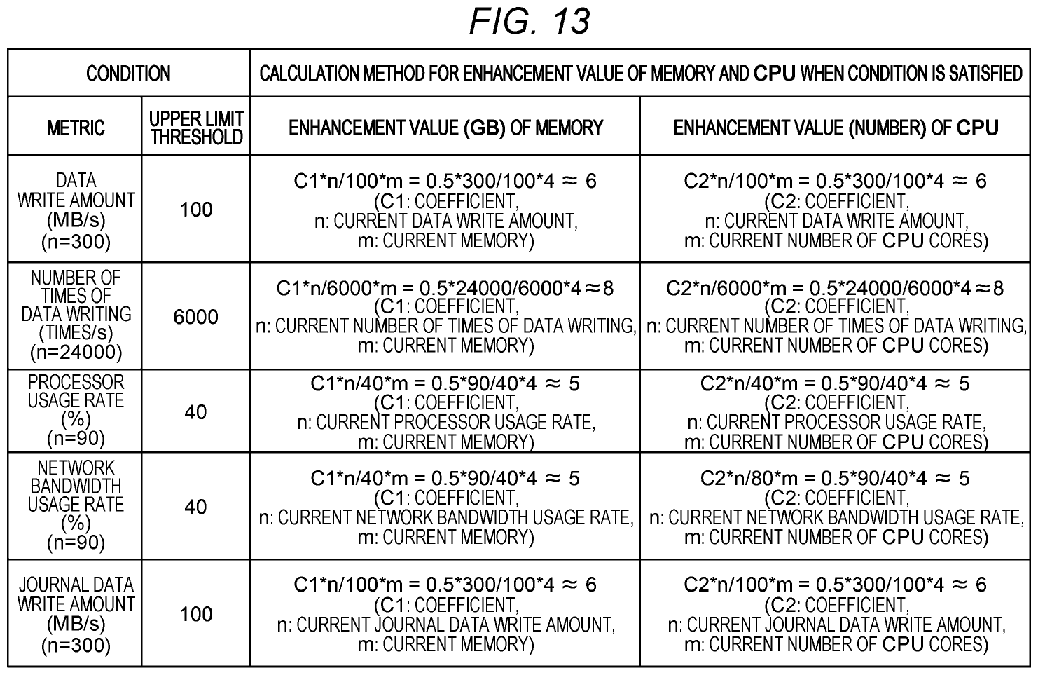

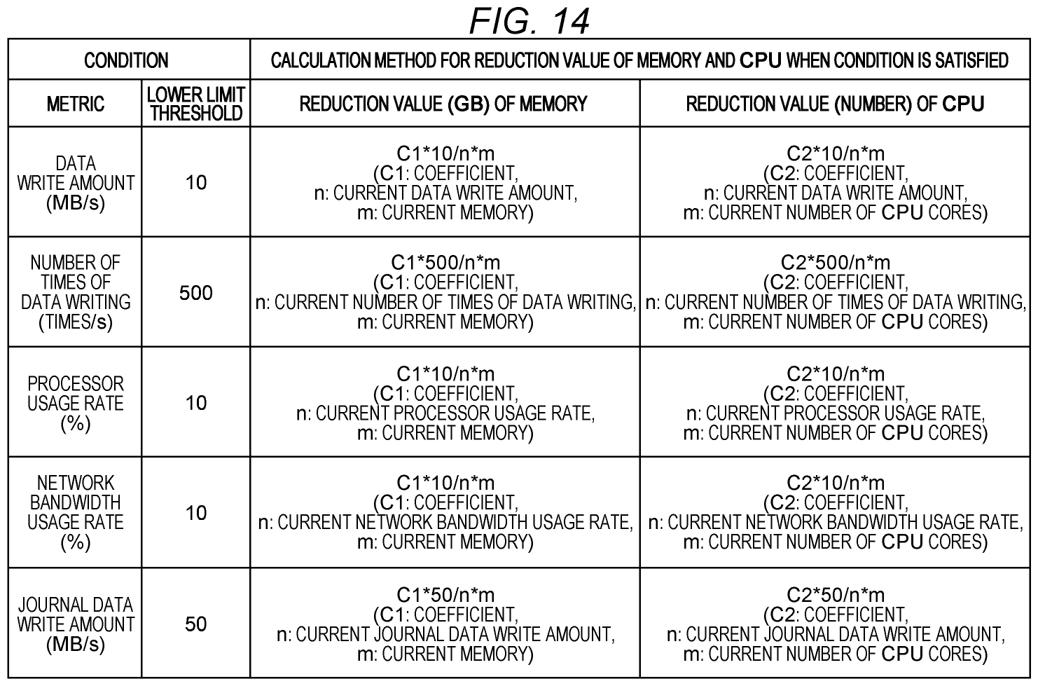

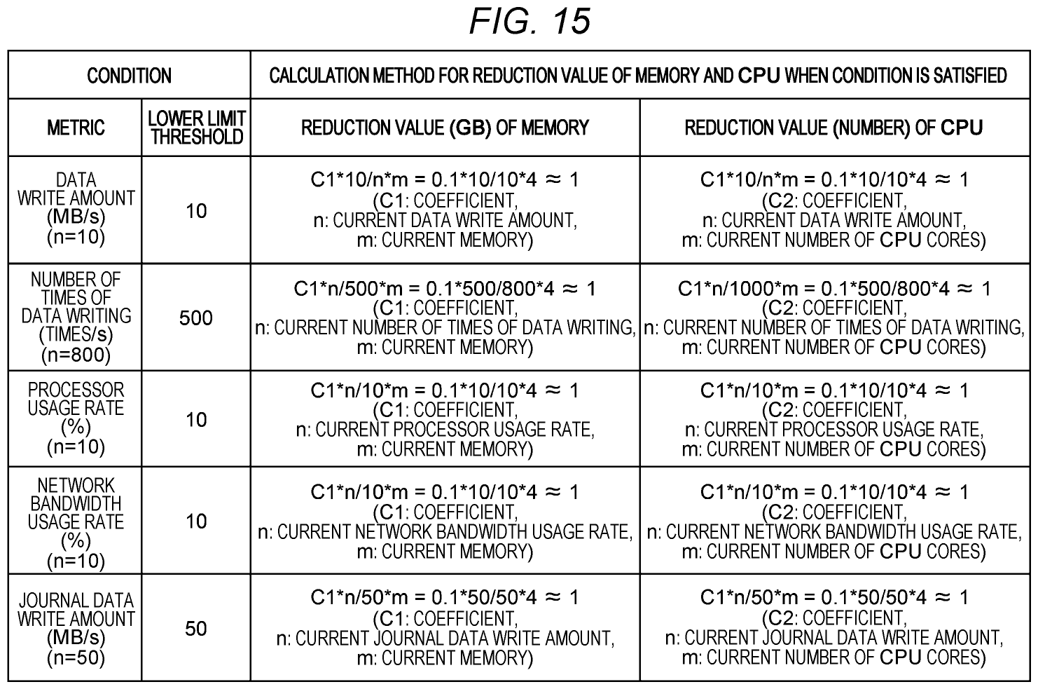

FIGS. 12 to 15 are diagrams illustrating an example of a calculation method for an enhancement value and a reduction value of a memory and a CPU when each condition is satisfied. Note that, in the present embodiment, the calculation method is also referred to as a “calculation method based on mapping of a condition and a calculation method”. FIGS. 12 and 13 are an example of a case where processing performance of a virtual computer of the storage device 300 in a cloud environment is enhanced, and FIGS. 14 and 15 are an example of a case where processing performance of a virtual computer of the storage device 300 in a cloud environment is reduced. In the illustrated examples, an upper threshold and a lower threshold are defined for each metric, and an enhancement value and a reduction value are determined according to an excess rate with respect to the threshold.

In the present embodiment, as illustrated in FIGS. 12 to 15, when each condition is satisfied, the performance information determination unit 454 calculates an enhancement value or a reduction value after a change in a memory or a CPU by using the calculation method illustrated in the drawing. Note that, in each calculation formula of the illustrated calculation method, C1 and C2 indicate predetermined coefficients, n indicates a current performance value, and m indicates a current memory or number of CPU cores.

The performance information determination unit 454 calculates an enhancement value of a memory or a CPU according to the calculation method as illustrated for a memory or a CPU, for example, with reaching an upper limit threshold (for example, 100) as a trigger for processing performance (for example, a data write amount) in a client environment illustrated as a metric in FIG. 12, for example.

The performance information determination unit 454 calculates an enhancement value of a memory or a CPU according to the calculation method as illustrated for a memory or a CPU, for example, with reaching an upper limit threshold (for example, 100) as a trigger for processing performance (for example, a data write amount) in a client environment illustrated as a metric in FIG. 13, for example.

The performance information determination unit 454 calculates a reduction value of a memory or a CPU according to the calculation method as illustrated for a memory or a CPU with reaching a lower limit threshold (for example, 10) as a trigger for processing performance (for example, a data write amount) in a client environment illustrated as a metric in FIG. 14, for example.

The performance information determination unit 454 calculates a reduction value of a memory or a CPU according to the calculation method as illustrated for a memory or a CPU with reaching a lower limit threshold (for example, 10) as a trigger for processing performance (for example, a data write amount) in a client environment illustrated as a metric in FIG. 15, for example.

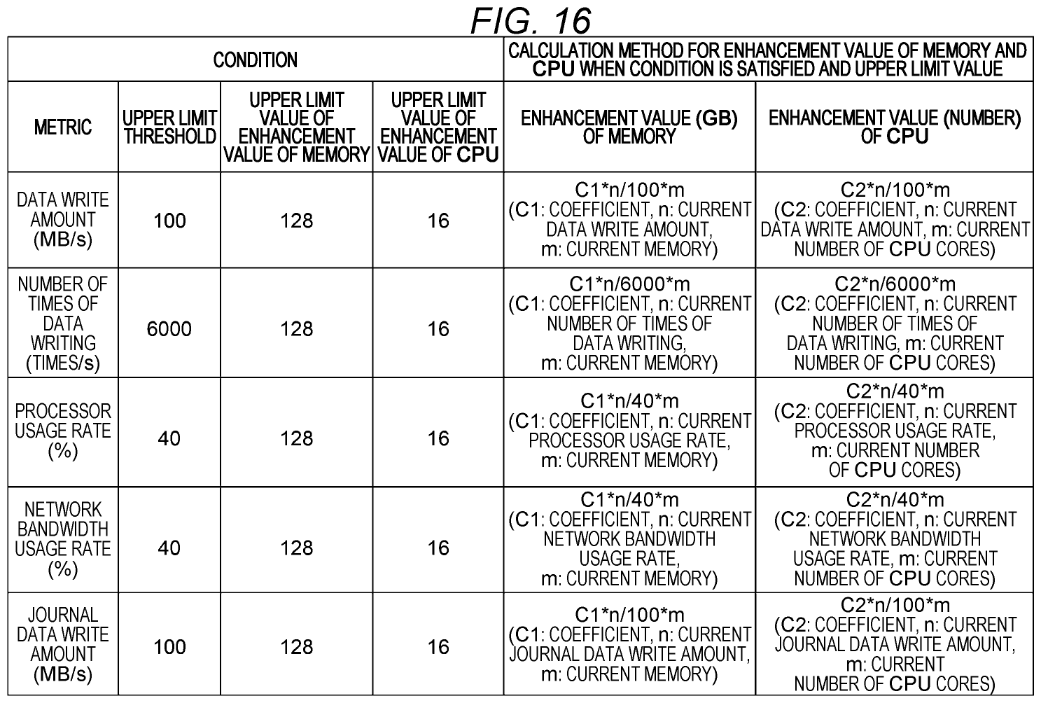

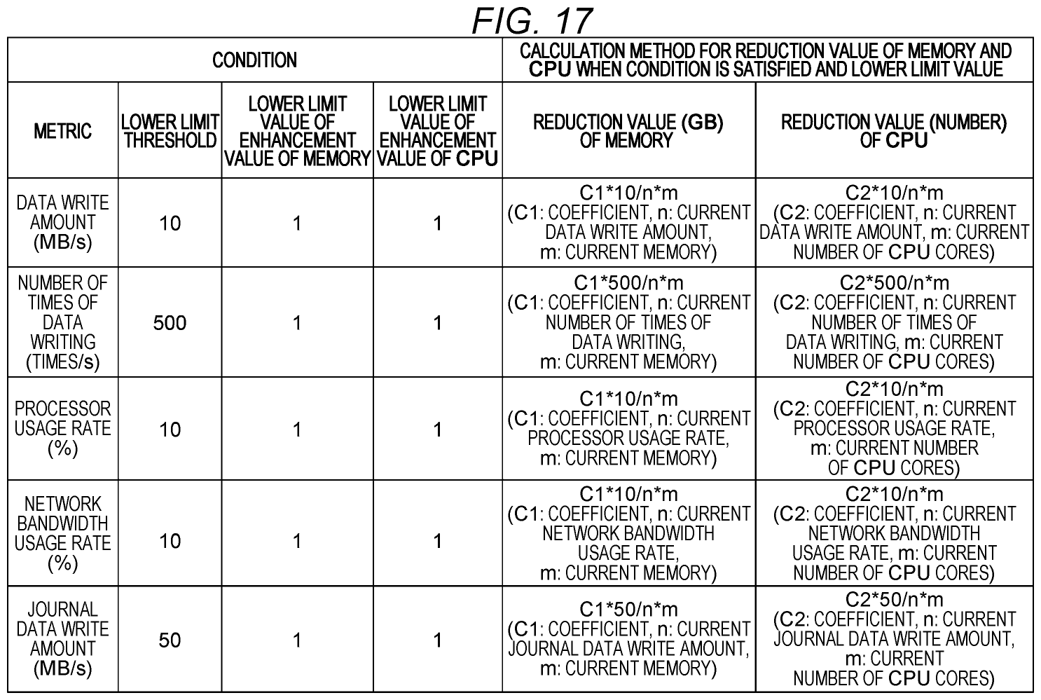

FIG. 16 is an example of an upper limit value after enhancement (corresponding to “upper limit value of enhancement value of . . . ” in the diagram) in a case where processing performance is enhanced as illustrated in FIG. 12, for example, and FIG. 17 is an example of a lower limit value after reduction (corresponding to “lower limit value of enhancement value of . . . ” in the diagram) in a case where processing performance is reduced as illustrated in FIG. 14, for example.

For example, in a case of enhancing a data write amount as processing performance, the processing performance change unit 455 sets an upper limit value of an enhancement value of a memory to “128” and sets an upper limit value of an enhancement value of a CPU to “16” as illustrated in FIG. 16.

On the other hand, for example, in a case of reducing a data write amount as processing performance, the processing performance change unit 455 sets a lower limit value of an enhancement value of a memory to “1” and sets a lower limit value of an enhancement value of a CPU to “1” as illustrated in FIG. 17.

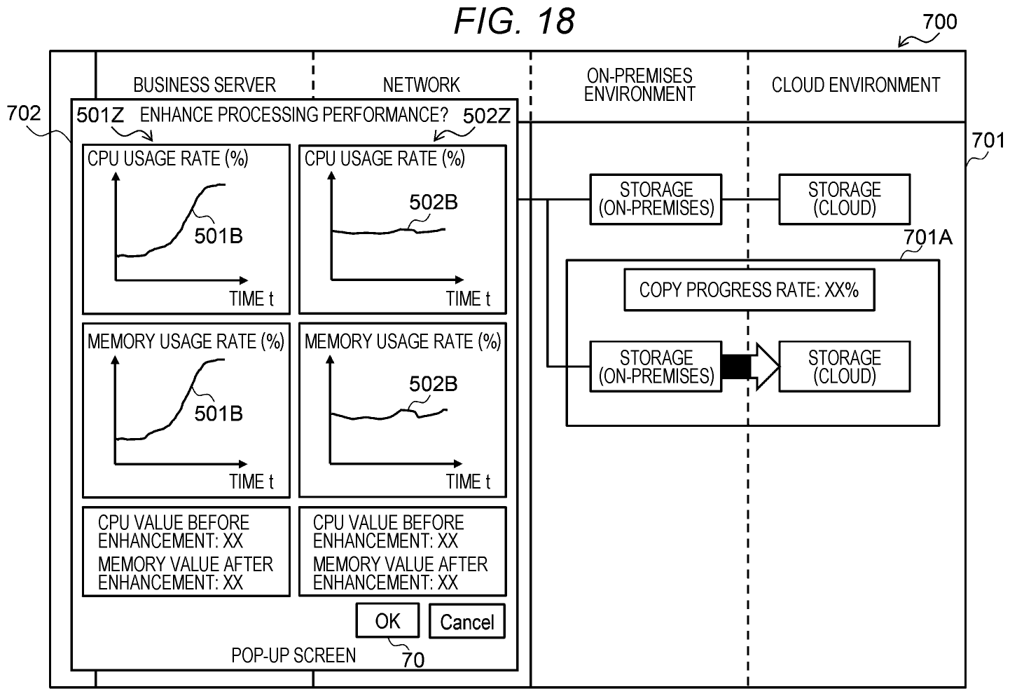

FIG. 18 is a diagram illustrating an example of a monitoring screen 700 according to the present embodiment. The monitoring screen 700 includes a main screen 701 and a processing performance change screen 702. The monitoring screen 700 is displayed by the processing performance change unit 455 of the processing performance adjustment unit 460.

On the main screen 701, monitoring statuses of the business server 100, the network 500, the storage device 200 in an on-premises environment, and the storage device 300 in a cloud environment are displayed from the left.

The main screen 701 including a progress status of asynchronous copy processing is displayed on the background of the processing performance change screen 702. The main screen 701 includes, on its right side, an asynchronous copy progress status screen 701A that displays, for example, a copy progress rate of asynchronous copy processing as a progress status of asynchronous copy between the storage device 200 in an on-premises environment and the storage device 300 in a cloud environment.

The processing performance change screen 702 includes, in its lower part, a CPU value before enhancement and a memory value before enhancement as an example of processing performance before change, and a CPU value after enhancement and a memory value after enhancement as an example of processing performance after change.

The processing performance change screen 702 includes an OK button 70 and a cancel button 71. The OK button 70 is a button pressed in a case where a CPU value before enhancement and a memory value before enhancement are changed to new performance values input to a CPU value before enhancement and a memory value before enhancement in order to change current performance values of the storage device 300 in a cloud environment displayed in a CPU value before enhancement and a memory value before enhancement in a lower part of the screen. The cancel button 71 is a button pressed in a case where the processing performance change screen 702 is erased and processing performance of the storage device 300 in a cloud environment is not changed.

On the other hand, the processing performance change screen 702 includes, for example, a first display field 501Z indicating an example of processing performance in a case where processing performance is changed on the side of the storage device 300 in a cloud environment described above with reference to FIG. 4, and a second display field 502Z indicating an example of processing performance in a case where processing performance is not changed.

The processing performance change screen 702 includes the first display field 501Z that displays a graph of transition of processing performance before change according to lapse of time including the first time point and the second time point, and the second display field 502Z that displays a transition graph of processing performance after change according to lapse of time including the first time point and the second time point. Display content and a function of the first display field 501Z and the second display field 502Z are substantially similar to the processing performance characteristic 501 and the processing performance characteristic 502 illustrated in FIG. 4, respectively, except for a type of processing performance, and thus, are omitted from description.

As described above, the storage system according to the present embodiment includes the storage device 200 in an on-premises environment as an example of one storage device that executes input and output processing of data in response to a request from the business server 100 as an example of a host device, the storage device 300 in a cloud environment as an example of another storage device that includes a virtual computer that executes asynchronous copy processing of asynchronously copying the data with the storage device 200 in an on-premises environment, in which processing performance of the virtual computer may be changed, and the processing performance adjustment unit 460 that changes in advance processing performance required at the second time point by the virtual computer of the storage device 300 in a cloud environment when asynchronous copy processing is executed at the second time point temporally later than the first time point in accordance with a state of the input and output processing at the first time point in the storage device 200 in an on-premises environment.

The asynchronous copy method of the storage system according to the present embodiment is an asynchronous copy method of a storage system including the storage device 300 in a cloud environment, in which processing performance of a virtual computer may be changed, the virtual computer executing asynchronous copy processing of asynchronously copying data with the storage device 200 in an on-premises environment that executes input and output processing of the data in response to a request from the business server 100, and the processing performance adjustment unit 460 executes a processing performance adjustment step of changing in advance processing performance required at the second time point temporally later than the first time point by a virtual computer of the storage device 300 in a cloud environment before the second time point when asynchronous copy processing is executed at the second time point according to a state of input and output processing at the first time point in the storage device 200 in an on-premises environment.

In this way, by preparing processing performance required in the future in the storage device 300 in a cloud environment in advance, it is possible to continuously maintain performance of a certain level or more regarding asynchronous copy processing between a plurality of sites (an on-premises environment and a cloud environment).

The asynchronous copy program according to the present embodiment is an asynchronous copy program of a storage system including the storage device 300 in a cloud environment, in which processing performance of a virtual computer may be changed, the virtual computer executing asynchronous copy processing of asynchronously copying data with the storage device 200 in an on-premises environment that executes input and output processing of data in response to a request from the business server 100, causes the processing performance adjustment unit 460 to execute, on a computer, a processing performance adjustment step of changing in advance processing performance required at the second time point temporally later than the first time point by a virtual computer of the storage device 300 in a cloud environment before the second time point when asynchronous copy processing is executed at the second time point according to a state of input and output processing at the first time point in the storage device 200 in an on-premises environment, and causes the processing performance adjustment unit 460 to execute, on a computer, a display step of displaying a predetermined screen for changing processing performance in advance.

In this way, in addition to the effect that it is possible to continuously maintain a certain level or more of performance regarding the asynchronous copy processing between a plurality of sites (an on-premises environment and a cloud environment) described above, it is possible to further check a status of asynchronous copy processing (for example, impossible, processing performance is enhanced or not) by monitoring asynchronous copy processing from a predetermined screen. In particular, when referring to a predetermined screen displayed in the display step, for example, the management user can visually recognize that performance of a certain level or more can be continuously maintained with respect to the asynchronous copy processing between a plurality of sites (an on-premises environment and a cloud environment) described above, for example. By this, for example, even in a case where performance of a certain level or more cannot be continuously maintained regarding the asynchronous copy processing, it is possible to visually recognize the performance, and it is possible to prepare in advance before the second time point for enhancement of processing performance of a virtual computer of the storage device 300 in a cloud environment. On the other hand, for example, even in a case where performance is higher than originally required for the asynchronous copy processing, it is possible to visually recognize the performance, and it is possible to prepare in advance before the second time point for reduction of processing performance of a virtual computer of the storage device 300 in a cloud environment.

In the present embodiment, in a case where a processing load is a threshold or more as a state of input and output processing at the first time point in the storage device 200 in an on-premises environment, the processing performance change unit 455 of the processing performance adjustment unit 460 changes processing performance required at the second time point by a virtual computer of the storage device 300 in a cloud environment to be high. In this way, by preparing processing performance required in the future in the storage device 300 in a cloud environment in advance, it is possible to continuously maintain performance of a certain level or more in asynchronous copy processing between a plurality of sites (an on-premises environment and a cloud environment).

In the present embodiment, in a case where a processing load is a threshold or less as a state of input and output processing at the first time point in the storage device 200 in an on-premises environment, the processing performance change unit 455 of the processing performance adjustment unit 460 changes processing performance required at the second time point by a virtual computer of the storage device 300 in a cloud environment to be low. In this way, by preparing for reduction in advance of processing performance that is not required in the future in the storage device 300 in a cloud environment, it is possible to improve processing performance of other elements as much as unnecessary processing performance can be omitted.

In the present embodiment, the storage device 200 in an on-premises environment includes the primary volume 299 as an example of one volume to which data is written, and the master journal 298 that stores a base journal corresponding to data written to the primary volume 299 and an update journal corresponding to a difference between data written after that and data already written to the primary volume 299. On the other hand, the storage device 300 in a cloud environment includes the restore journal 398 to which a base journal and an update journal stored in the master journal 298 are copied, and the secondary volume 399 as an example of another volume on which data is restored based on the restore journal 398.

In the present embodiment, the processing performance change unit 455 of the processing performance adjustment unit 460 changes processing performance of at least one of a memory and a processor included in the storage device 300 in a cloud environment as processing performance of the storage device 300 in a cloud environment. In this way, by preparing processing performance of at least one of a memory and a processor required in the future in the storage device 300 in a cloud environment in advance, it is possible to continuously maintain performance of a certain level or more in asynchronous copy processing between a plurality of sites (an on-premises environment and a cloud environment).

In the present embodiment, the processing performance adjustment unit 460 displays, as a predetermined screen, the processing performance change screen 702 including processing performance before change (at least one of a CPU value before enhancement and a memory value before enhancement) and processing performance after change (a CPU value after enhancement and a memory value after enhancement). In this way, it is possible to consider how much processing performance after change should be while visually checking processing performance before change and processing performance after change.

In the present embodiment, the processing performance change screen 702 includes a graph of transition of processing performance before change according to lapse of time including the first time point and the second time point (the first display field 501Z), and a transition graph of processing performance after change according to lapse of time including the first time point and the second time point (the second display field 502Z). In this way, it is possible to consider how much processing performance after change should be while visually checking a graph of transition of processing performance before change and a graph of transition of processing performance after change.

In the present embodiment, the main screen 701 including a progress status of asynchronous copy processing is displayed on the background of the processing performance change screen 702. In this way, it is possible to check processing performance before change and processing performance after change while checking a progress status of asynchronous copy processing with reference to the main screen 701.

Note that the present invention is not limited to the above-described embodiment, and includes various variations and equivalent configurations within the scope of the appended claims. For example, the above embodiment is described in detail for easy understanding of the present invention, and the present invention is not necessarily limited to one that includes all the described configurations. Further, elements described to be in parallel in the present embodiment may have an aspect in which at least one of the elements is connected in series to another element.

### INDUSTRIAL APPLICABILITY

The present invention can be applied to a storage system related to a technique of executing asynchronous copy between a plurality of sites.

What is claimed is:

1. A storage system, comprising:
one storage device that executes input and output processing of data in response to a request from a host device;
another storage device that includes a virtual computer that executes asynchronous copy processing of asynchronously copying the data with the one storage device, processing performance of the virtual computer being able to be changed; and
a processing performance adjustment unit that changes in advance processing performance required at a second time point temporally later than a first time point by the virtual computer of the other storage device before the second time point when the asynchronous copy processing is executed at the second time point according to a state of the input and output processing at the first time point in the one storage device.

2. The storage system according to claim 1, wherein
the processing performance adjustment unit changes processing performance required at the second time point by the virtual computer of the other storage device to be high in a case where a processing load is equal to or more than a threshold as a state of the input and output processing at the first time point in the one storage device.

3. The storage system according to claim 1, wherein
the processing performance adjustment unit changes processing performance required at the second time point by the virtual computer of the other storage device to be low in a case where a processing load is equal to or less than a threshold as a state of the input and output processing at the first time point in the one storage device.

4. The storage system according to claim 1, wherein
the one storage device includes:
one volume to which the data is written; and
a master journal that stores a base journal corresponding to data written in the one volume and an update journal corresponding to a difference between data written thereafter and data already written to the one volume, and
the other storage device includes:
a restore journal to which the base journal and the update journal stored in the master journal are copied; and
another volume in which the data is restored based on the restore journal.

5. The storage system according to claim 1, wherein
the processing performance adjustment unit changes processing performance of at least one of a memory and a processor included in the other storage device as processing performance of the other storage device.

6. The storage system according to claim 1, wherein
the processing performance adjustment unit displays a processing performance change screen including:
the processing performance before change; and
the processing performance after change.

7. The storage system according to claim 6, wherein
the processing performance change screen includes:
a graph of transition of the processing performance before change according to lapse of time including the first time point and the second time point; and
a transition graph of the processing performance after change according to lapse of time including the first time point and the second time point.

8. The storage system according to claim 6, wherein
a main screen including a progress status of the asynchronous copy processing is displayed on a background of the processing performance change screen.

9. An asynchronous copy method of a storage system including another storage device in which processing performance of a virtual computer that executes asynchronous copy processing of asynchronously copying data with one storage device that executes input and output processing of the data in response to a request from a host device can be changed, wherein
a processing performance adjustment unit executes a processing performance adjustment step for changing in advance processing performance required at a second time point temporally later than a first time point by the virtual computer of the other storage device before the second time point when the asynchronous copy processing is executed at the second time point according to a state of the input and output processing at the first time point in the one storage device.

10. An asynchronous copy program of a storage system including another storage device in which processing performance of a virtual computer that executes asynchronous copy processing of asynchronously copying data with one storage device that executes input and output processing of the data in response to a request from a host device can be changed, the asynchronous copy program causing:
a processing performance adjustment unit to execute, on a computer, a processing performance adjustment step of changing in advance processing performance required at a second time point temporally later than a first time point by the virtual computer of the other storage device before the second time point when asynchronous copy processing is executed at the second time point according to a state of the input and output processing at the first time point in the one storage device; and
a processing performance adjustment unit to execute, on a computer, a display step of displaying a predetermined screen for changing the processing performance in advance.
